(19) United States
(12) Patent Application Publication
(10) Pub. No.: US 2026/0217036 A1
(43) Pub. Date: Jul. 30, 2026

(54) LIQUID EJECTION APPARATUS, IMAGE FORMING APPARATUS, AND IMAGE FORMING SYSTEM

(71) Applicant: Kenta TAKAHASHI, Kanagawa (JP)

(72) Inventor: Kenta TAKAHASHI, Kanagawa (JP)

(21) Appl. No.: 19/454,442

(22) Filed: Jan. 21, 2026

(30) Foreign Application Priority Data
Jan. 29, 2025 (JP) 2025-013181

(51) Int. Cl. B41J 2/18; B41J 2/175; B41J 2/21; B41J 11/00

(52) U.S. Cl. CPC B41J 2/18; B41J 2/17596; B41J 11/002; B41J 11/0095; B41J 2/2103

(57) ABSTRACT

A liquid ejection apparatus, having a circulation channel through which liquid is supplied to a liquid ejection head and recovered from the liquid ejection head, includes a conveyor configured to convey a recording medium; a paper jam detector configured to detect a paper jam of the recording medium; and a controller. The circulation channel includes a first manifold leading to a supply port of the liquid ejection head, a second manifold leading to a recovery port of the liquid ejection head via a recovery channel, a drainage channel branching from the recovery channel, a drainage tank leading to the drainage channel, and a switching mechanism configured to switch between a first state in which the recovery port of the liquid ejection head communicates with the second manifold and a second state in which the recovery port of the liquid ejection head communicates with the drainage channel.

### CROSS-REFERENCE TO RELATED APPLICATIONS

This application is based on and claims priority to Japanese Patent Application No. 2025-013181, filed on Jan. 29, 2025, the entire contents of which are incorporated herein by reference.

### BACKGROUND OF THE INVENTION

### 1. Field of the Invention

The present disclosure relates to a liquid ejection apparatus, an image forming apparatus, and an image forming system.

### 2. Description of the Related Art

As a liquid ejection head, an ink circulation head (hereinafter also simply referred to as a “circulation head”) having a supply channel and a recovery channel, and configured to circulate ink is known. The supply channel leads to an individual liquid chamber communicating with a nozzle and the recovery channel leads to the individual liquid chamber.

For example, in the case of a system in which K, C, M, and Y circulation heads are arranged in this order in the conveyance direction of a recording medium and an image is formed by ejecting ink to the recording medium in this order (in the case of a line head system), if a paper jam of the recording medium occurs at a time when the recording medium is printed with C color ink after being printed with K color ink, the K color ink on the recording medium may adhere to a nozzle of the C circulation head and enter the nozzle. Further, in a case where treatment liquid for coagulating (coarsely precipitating) pigments in ink by contacting the ink is applied to the recording medium in order to improve fixability on the recording medium 11, the treatment liquid on the recording medium may adhere to the nozzle of the circulation head and enter the nozzle if a paper jam of the recording medium occurs.

As described, there is a possibility that different color ink or treatment liquid enters not only a nozzle but also a supply channel by a circulation operation of a circulation head. In particular, there is a possibility that the treatment liquid coagulates when contacting the ink in the nozzle or in the supply channel, and the nozzle or the supply channel may be clogged due to generated aggregates.

For example, Patent Document 1 describes a liquid ejection apparatus including: an ejecting unit including a first ejecting unit configured to eject liquid onto a medium, and a second ejecting unit configured to eject reaction liquid containing a coagulant for coagulating a component in the liquid onto the medium; a transport unit configured to transport the medium; a paper jam detector; and a control unit configured to control the ejecting unit and the transport unit. When a paper jam is detected by the paper jam detector, the control unit stops the transportation of the medium by the transport unit, and ejects, within a printing region, at least one of the liquid or the reaction liquid from the first ejecting unit or the second ejecting unit.

### RELATED-ART DOCUMENTS

### Patent Documents

Patent Document 1: Japanese Unexamined Patent Application Publication No. 2023-89489

### SUMMARY OF THE INVENTION

According to an embodiment of the present disclosure, a liquid ejection apparatus having a circulation channel through which liquid is supplied to a liquid ejection head and recovered from the liquid ejection head is provided. The liquid ejection apparatus includes a conveyor configured to convey a recording medium; a paper jam detector configured to detect a paper jam of the recording medium; and a controller. The circulation channel includes a first manifold leading to a supply port of the liquid ejection head, a second manifold leading to a recovery port of the liquid ejection head via a recovery channel, a drainage channel branching from the recovery channel, a drainage tank leading to the drainage channel, and a switching mechanism configured to switch between a first state in which the recovery port of the liquid ejection head communicates with the second manifold and a second state in which the recovery port of the liquid ejection head communicates with the drainage channel. The controller controls the switching mechanism such that the first state is switched to the second state after the paper jam is detected by the paper jam detector.

### BRIEF DESCRIPTION OF THE DRAWINGS

FIG. 1 is a schematic diagram illustrating an example of an image forming system according to an embodiment;

FIG. 2 is a plan view illustrating an example configuration of liquid ejection units;

FIG. 3 is a front view illustrating an example configuration of the liquid ejection units;

FIG. 4 is a perspective view of a liquid ejection head;

FIG. 5 is a cross-sectional view of the liquid ejection head taken along a plane including a conveyance direction of a recording medium;

FIG. 6 is a diagram illustrating a configuration related to liquid circulation in an image forming apparatus according to the present embodiment;

FIG. 7 is a block diagram illustrating an example of a hardware configuration of a controller;

FIG. 8 is a flowchart illustrating an example of the operation of the image forming apparatus when a paper jam occurs;

FIG. 9 is a diagram illustrating the flow of liquid during normal printing in the image forming apparatus according to the present embodiment;

FIG. 10A is a diagram illustrating a state in normal printing;

FIG. 10B is a diagram illustrating a state when a paper jam occurs;

FIG. 11A is a diagram illustrating the operation of a paper jam detector;

FIG. 11B is a diagram illustrating the operation of the paper jam detector;

FIG. 12 is a diagram illustrating the flow of liquid when a paper jam occurs in the image forming apparatus according to the present embodiment;

FIG. 13 is a flowchart illustrating an example of the operation of the image forming apparatus when a paper jam occurs;

FIG. 14 is a flowchart illustrating an example of the operation of the image forming apparatus when a paper jam occurs; and

FIG. 15 is a flowchart illustrating an example of the operation of the image forming apparatus when a paper jam occurs.

### DESCRIPTION OF THE EMBODIMENTS

In the liquid ejection apparatus described in Patent Document 1, paper jams caused when a medium contacts a head unit or a carriage during roll media printing has been studied, whereas no consideration is given to cases in which cut sheet printing is performed. In the case of cut sheet printing, when a paper jam occurs, a medium originally intended to be printed cannot be conveyed, and thus the medium is often not present in a printing region. If ink is ejected into the printing region as in the liquid ejection apparatus described in Patent Document 1, the ink is ejected directly onto a recording medium supporting member such as a platen, thereby resulting in a problem in which the recording medium supporting member becomes contaminated.

According to an embodiment of the present disclosure, it is desirable to provide a liquid ejection apparatus that can discharge different color ink or pretreatment liquid that has entered a nozzle of an ink circulation head due to the occurrence of a paper jam, without contaminating a recording medium supporting member.

An embodiment of the present disclosure will be described below with reference to the accompanying drawings. In the drawings, the same components are denoted by the same reference numerals, and duplicate descriptions will be omitted.

The present invention is not limited to the following embodiment. Unless otherwise specified, the dimensions, materials, shapes, relative arrangements, and the like of components described below are not intended to limit the scope of the present invention thereto, but rather are described as examples. Further, the sizes, positional relationships, and the like of members illustrated in the drawings may be exaggerated for a better understanding of the structures.

The embodiment will be described below by using a liquid-ejection-type image forming apparatus and an image forming system including the image forming apparatus as examples. The image forming apparatus includes a liquid ejection heads configured to eject liquid and form an image on a recording medium by using the liquid ejected from the liquid ejection head. In the terminology of the embodiment, image formation, recording, printing are synonymous.

Although liquid to be ejected is not particularly limited as long as the liquid has a viscosity and a surface tension capable of being ejected from the liquid ejection head, it is preferable that the liquid has a viscosity of 30 mPa·s or less under normal temperature and pressure, or through heating and cooling. More specifically, examples of the liquid include solutions, suspensions, emulsions and the like containing solvents such as water and organic solvents, colorants such as dyes and pigments, function-imparting materials such as polymerizable compounds, resins, and surfactants, biocompatible materials such as DNA, amino acids, proteins, and calcium, and edible materials such as natural pigments. These can be used, for example, in inkjet inks.

Further, the liquid ejection head is a functional component that ejects and discharges liquid from a nozzle. Examples of energy sources for ejecting liquid include those using piezoelectric actuators (laminated piezoelectric elements and thin-film piezoelectric elements), thermal actuators using electrothermal conversion elements such as heating resistors, and electrostatic actuators consisting of a vibration plate and counter electrodes.

### Image Forming System

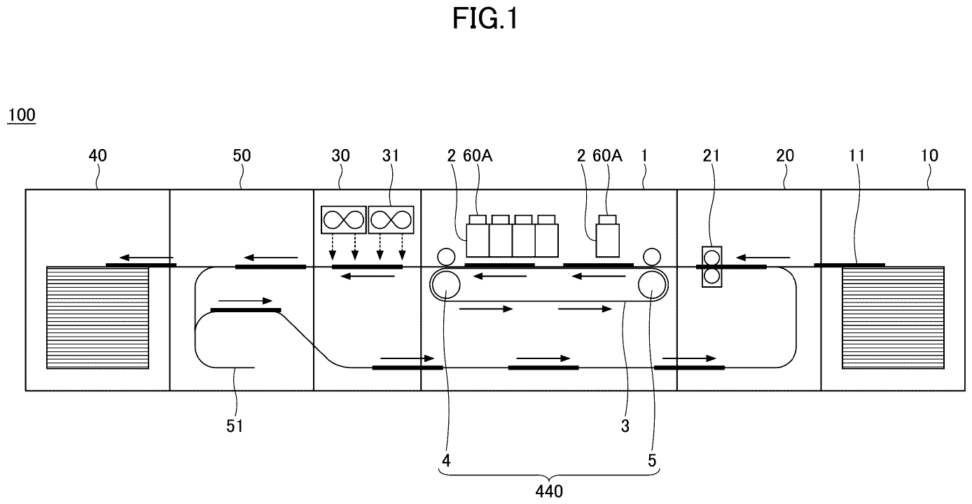

FIG. 1 is a schematic diagram illustrating an example of an image forming system 100 according to an embodiment. As illustrated in FIG. 1, the image forming system 100 according to the present embodiment includes an image forming apparatus 1. The image forming apparatus 1 includes a liquid ejection unit 2 including a liquid ejection head configured to eject ink by an inkjet method, and a conveying belt (recording medium supporting member) 3 configured to convey a recording medium 11 such as paper while holding the recording medium 11 on the surface of the conveying belt 3.

Further, the image forming system 100 includes a paper feeder 10 configured to feed the recording medium 11 loaded thereon, and a registration adjuster 20 configured to perform registration correction of the recording medium 11. The paper feeder 10 is located upstream of the image forming apparatus 1 in the conveyance direction of the recording medium 11. The image forming system 100 includes, downstream of the image forming apparatus 1 in the conveyance direction of the recording medium 11, a dryer 30 configured to dry the recording medium 11 on which an image is formed by an inkjet method, a paper ejector 40 configured to eject the dried recording medium 11, and a paper reversing and conveying device 50 configured to further form an image on the back surface of the recording medium 11.

Next, a series of image forming operations for forming an image on the recording medium 11 by the image forming system 100 according to the present embodiment will be described.

In FIG. 1, first, each recording medium 11 loaded on the paper feeder 10 is separated and picked up one by one. The paper feeder 10 may include, for example, an air separation device using air. The picked up recording medium 11 is conveyed to the registration adjuster 20 on the downstream side in the conveying direction of the recording medium 11 toward the image forming apparatus 1.

The recording medium 11 conveyed from the paper feeder 10 reaches the registration adjuster 20. In the registration adjuster 20, a registration roller 21 provided therein performs registration correction of the recording medium 11. After the registration correction of the recording medium 11 is performed by the registration adjuster 20, the recording medium 11 is conveyed to the image forming apparatus 1 at a predetermined timing.

The recording medium 11 subjected to the registration correction and conveyed to the image forming apparatus 1 is conveyed onto the surface of the conveying belt 3. The conveying belt 3 has multiple air intake holes in the surface thereof. By sucking air through the multiple air intake holes from the back side of the recording medium 11, the entire recording medium 11 is closely attached and held onto the surface of the conveying belt 3. As the conveying belt 3 is rotated in a direction indicated by arrows in FIG. 1, the recording medium 11 closely attached and held onto the surface of the conveying belt 3 by sucking air is conveyed toward the liquid ejection unit 2.

In the image forming apparatus 1, a plurality of liquid ejection units 2 each filled with ink of a predetermined color are sequentially arranged along the surface of the conveying belt 3 in a state. The recording medium 11 held on the surface of the conveying belt 3 is conveyed under the liquid ejection units 2 corresponding to respective colors, and ink of the respective colors is ejected from nozzles of liquid ejection heads 60, which will be described later, of each of the liquid ejection units 2 at a predetermined timing, thereby forming an image on the surface of the recording medium 11.

The image forming apparatus 1 includes a conveyor 440 configured to convey the recording medium 11 as will be described later. The conveyor 440 includes, for example, the conveying belt 3 and conveying rollers 4 and 5. The recording medium 11 on which an image is formed by the image forming apparatus 1 is conveyed to the dryer 30 by the conveyor 440. The dryer 30 includes a drying unit 31. Moisture in the ink evaporates as the recording medium 11 passes under the drying unit 31, thereby preventing the recording medium 11 from curling.

The recording medium 11 that has passed through the dryer 30 is conveyed to the paper ejector 40 on which recording mediums 11 are stacked and aligned orderly. Further, the paper reversing and conveying device 50 includes a paper reversing device 51. In a duplex printing mode, the recording medium 11 is reversed and conveyed to the image forming apparatus 1 again. After the paper reversing device 51 switches the conveyance direction of the recording medium, the paper reversing and conveying device 50 conveys the recording medium 11 toward the image forming apparatus 1.

Before the recording medium 11 reaches the conveying belt 3, the registration roller 21 performs registration correction. The recording medium 11 subjected to the registration correction is conveyed to the conveying belt 3, and is held on the surface of the conveying belt 3 with the back surface having no image thereon facing up. Then, in the image forming apparatus 1, the liquid ejection heads of the liquid ejection units 2 form an image on the back surface (having no image formed) of the recording medium 11 that is held on the surface of the conveying belt 3.

After passing through the dryer 30, the recording medium 11 has respective images on both sides. Then, similar to a single-side printing mode, the recording medium 11 is conveyed to the paper ejector 40 and is stacked and aligned orderly on the paper ejector 40.

### Image Forming Apparatus

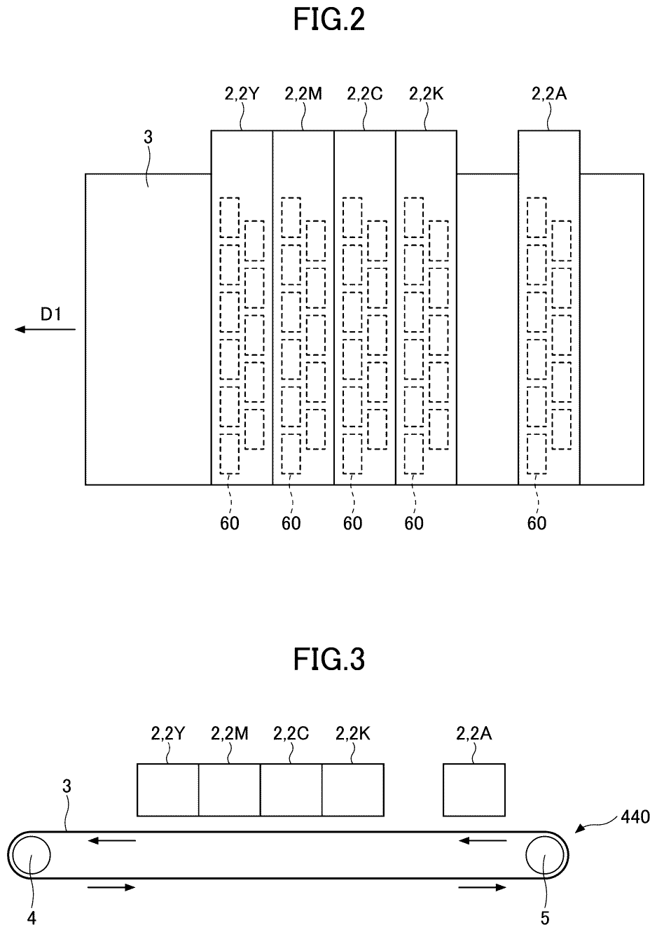

Next, the image forming apparatus 1 serving as a liquid ejection apparatus will be described. FIG. 2 is a plan view illustrating an example configuration of the liquid ejection units 2. FIG. 3 is a front view illustrating an example configuration of the liquid ejection units 2 (viewed in a direction along the rotation axis of the conveying belt 3). In FIG. 2, carriages 60A are not depicted.

Specifically, as illustrated in FIGS. 2 and 3, the liquid ejection units 2 according to the present embodiment may include a liquid ejection unit 2A serving as a as a pretreatment liquid applicator and configured to eject pretreatment liquid, and liquid ejection units 2K, 2C, 2M, and 2Y configured to eject inks of four colors (hereinafter referred to as “liquid ejection units 2” when the colors and the pretreatment liquid are not distinguished), which are arranged in order from the upstream side of a conveyance direction D1 of the recording medium 11. The liquid ejection units 2A, 2K, 2C, 2M, and 2Y eject pretreatment liquid A, black K ink, cyan C ink, magenta M ink, and yellow Y ink to the recording medium 11 to be conveyed, respectively. The kinds and the numbers of colors are not limited thereto.

Each of the liquid ejection units 2A, 2K, 2C, 2M, and 2Y is of a line-engine type and includes a plurality of liquid ejection heads 60 arranged along the main scanning direction. Specifically, the plurality of liquid ejection heads 60 are arranged such that rows extending in the main scanning direction are arranged along the conveyance direction D1 of the recording medium 11 and are arranged in a staggered pattern. However, the number, the arrangement, and the like of the liquid ejection heads 60 are not limited to those illustrated in FIG. 2 and can be appropriately changed.

The pretreatment liquid has a function for coagulating (or precipitating) pigments in ink by contacting the ink so as to improve fixability on the recording medium 11. Image quality can be enhanced by an image forming method using the pretreatment liquid and ink. As the pretreatment liquid, for example, as described in Japanese Patent No. 4,053,720, it is possible to use liquid containing a coagulant (a cationic metal, for example) for electrically bonding to and coagulating (anionic) pigments serving as coloring materials such that the pigments are fixed on the surface.

An example of an image forming method using the pretreatment liquid and ink will be described. First, a pretreatment liquid application layer is formed by applying the pretreatment liquid to the recording medium 11. An application method of the pretreatment liquid according to the present embodiment is droplet application by the liquid ejection unit 2A. However, the application method is not limited thereto, and the pretreatment liquid may be applied by a roller or the like. Alternatively, a pre-treated recording medium 11 to which the pretreatment liquid has been applied in advance may be used.

That is, the image forming apparatus (liquid ejection apparatus) 1 may include the plurality of ink ejection units 2K, 2C, 2M, and 2Y configured to eject inks of mutually different colors from liquid ejection heads 60, and a pretreatment liquid applicator configured to apply the pretreatment liquid to the recording medium 11. Hereinafter, the pretreatment liquid applicator is also denoted by the reference numeral 2A. The plurality of ink ejection units 2K, 2C, 2M, and 2Y are arranged downstream of the pretreatment liquid applicator 2A in the conveyance direction D1. The pretreatment liquid applicator 2A may be a pretreatment liquid ejection unit configured to eject the pretreatment liquid from liquid ejection heads 60, or a roller application device configured to that apply the pretreatment liquid to the recording medium.

The recording medium 11 on which the pretreatment liquid application layer is formed is relatively moved directly under the four color ink ejection units 2K, 2C, 2M, and 2Y. At this time, the recording medium 11 may be conveyed, or the heads may be moved. Then, ink is ejected to the pretreatment liquid application layer on the recording medium 11, and an image is formed.

The liquid ejection heads 60 of the pretreatment liquid ejection unit 2A are preferably disposed upstream of liquid ejection heads 60 of the four color ink ejection units 2K, 2C, 2M, and 2Y in the conveyance direction D1. In addition, the liquid ejection heads 60 of the pretreatment liquid ejection unit 2A are preferably provided at a distance from the liquid ejection heads 60 of the four color ink ejection units 2K, 2C, 2M, and 2Y because there is a possibility that a portion of the ejected pretreatment liquid scattered in the form of a mist without landing on the recording medium 11, or a portion of the ejected pretreatment liquid bounced after landing on the recording medium 11 adheres to an object downstream of the conveyance direction D1.

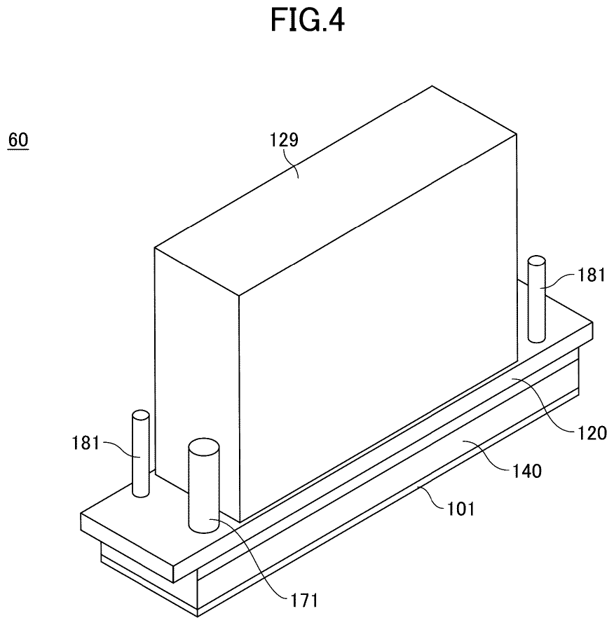

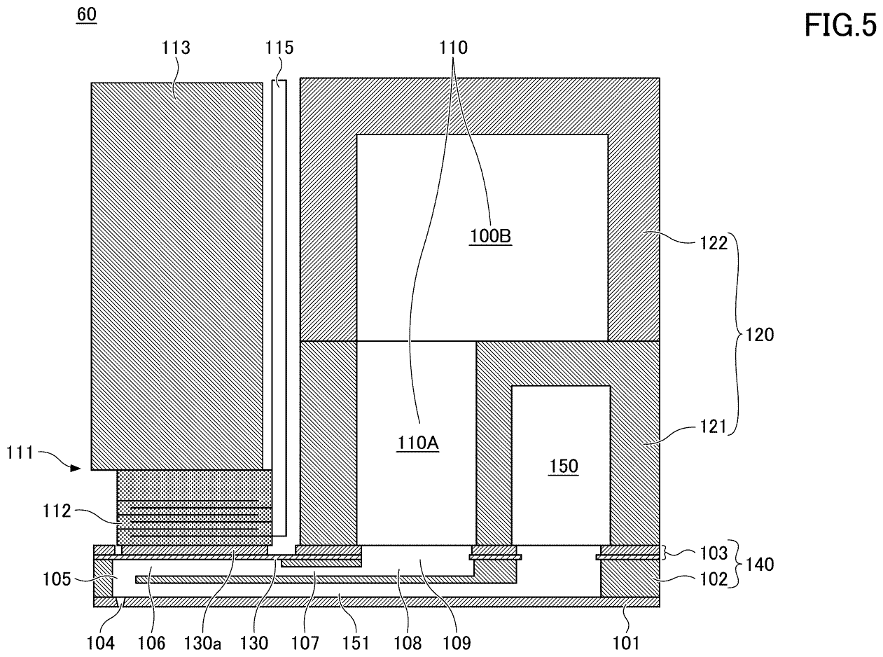

FIG. 4 is a perspective view of a liquid ejection head 60. FIG. 5 is a cross-sectional view of the liquid ejection head 60 taken along a plane including the conveyance direction D1 of the recording medium 11. As illustrated in FIGS. 4 and 5, the liquid ejection head 60 includes a nozzle plate 101, a channel plate 102, and a vibration plate member 103 serving as a wall surface member. The nozzle plate 101, the channel plate 102, and the vibration plate member 103 are laminated in this order and bonded to one another.

Further, the liquid ejection head 60 includes a piezoelectric actuator 111 that displaces a vibration region (vibration plate) 130 of the vibration plate member 103, a common liquid chamber member 120 serving also as a frame member of the head, and a cover 129. The channel plate 102 and the vibration plate member 103 constitutes a channel member 140.

The nozzle plate 101 includes a plurality of nozzles 104 that eject liquid.

The channel plate 102 includes through-holes and grooves that form an individual liquid chamber 106 communicating with the nozzles 104 via a nozzle communication channel 105, a supply-side fluid restrictor 107 communicating with the individual liquid chamber 106, and a liquid introduction portion 108 communicating with the supply-side fluid restrictor 107. The nozzle communication channel 105 is a channel extending to communicate with each of the nozzles 104 and the individual liquid chamber 106. Further, the liquid introduction portion 108 communicates with a supply-side common liquid chamber 110 via an opening 109 of the vibration plate member 103.

The vibration plate member 103 has the deformable vibration region 130 that forms the wall surface of the individual liquid chamber 106 of the channel plate 102. Here, the vibration plate member 103 has a two-layer structure (but is not limited thereto), and includes a first layer forming a thin portion and a second layer forming a thick portion in order from the channel plate 102 side. The deformable vibration region 130 is formed in a portion of the first layer corresponding to the individual liquid chamber 106.

The piezoelectric actuator 111 is disposed on the side opposite to the individual liquid chamber 106 of the vibration plate member 103. The piezoelectric actuator 111 includes an electromechanical transducer as a drive unit (an actuator unit or a pressure generation unit) to deform the vibration region 130 of the vibration plate member 103

In this piezoelectric actuator 111, a piezoelectric member bonded on a base member 113 is subjected to groove-processed by half-cut dicing such that a desired number of columnar piezoelectric elements 112 are formed at predetermined intervals in a comb shape.

A piezoelectric element 112 is bonded to a protrusion 130a, which is an island-shaped thick portion formed in the vibration region 130 of the vibration plate member 103. A flexible wiring member 115 is connected to the piezoelectric element 112.

The common liquid chamber member 120 forms the supply-side common liquid chamber 110 and a recovery-side common chamber 150. The supply-side common liquid chamber 110 communicates with a supply port 171, and the recovery-side common chamber 150 communicates with a recovery port 181.

In this case, the common liquid chamber member 120 includes a first common liquid chamber member 121 and a second common liquid chamber member 122. The first common liquid chamber member 121 is bonded to the vibration plate member 103 of the channel member 140, and the second common liquid chamber member 122 is stacked on and bonded to the first common liquid chamber member 121.

The first common liquid chamber member 121 forms a downstream-side common liquid chamber 110A and the recovery-side common chamber 150. The downstream-side common liquid chamber 110A is a part of the supply-side common liquid chamber 110 communicating with the liquid introduction portion 108, and the recovery-side common chamber 150 communicates with a recovery channel 151. Further, the second common liquid chamber member 122 forms an upstream-side common liquid chamber 110B, which is the remaining part of the supply-side common liquid chamber 110.

Further, the channel plate 102 forms the recovery channel 151 along the surface direction of the channel plate 102 communicating with each individual liquid chamber 106 via the nozzle communication channel 105. The recovery channel 151 communicates with the recovery-side common chamber 150.

In the liquid ejection head 60, for example, when voltage lower than a reference potential (intermediate potential) is applied to the piezoelectric element 112, the piezoelectric element 112 contracts. Accordingly, the vibration region 130 of the vibration plate member 103 is pulled to increase the volume of the individual liquid chamber 106, thereby causing liquid to flow into the individual liquid chamber 106.

Thereafter, the voltage applied to the piezoelectric element 112 is increased to elongate the piezoelectric element 112 in the stacking direction, and the vibration region 130 of the vibration plate member 103 deforms in a direction toward the nozzles 104 and the volume of the individual liquid chamber 106 decreases. Thus, liquid in the individual liquid chamber 106 is ejected from the nozzles 104.

Liquid not ejected from the nozzles 104 passes by the nozzles 104 and flows from the recovery channel 151 into the recovery-side common chamber 150 and is supplied from the recovery-side common chamber 150 to the supply-side common liquid chamber 110 again through an external circulation channel L10 described later.

Note that the method of driving the head is not limited to the above example (pull-push ejection), pull ejection or push ejection can be performed in accordance with the way the drive waveform is applied.

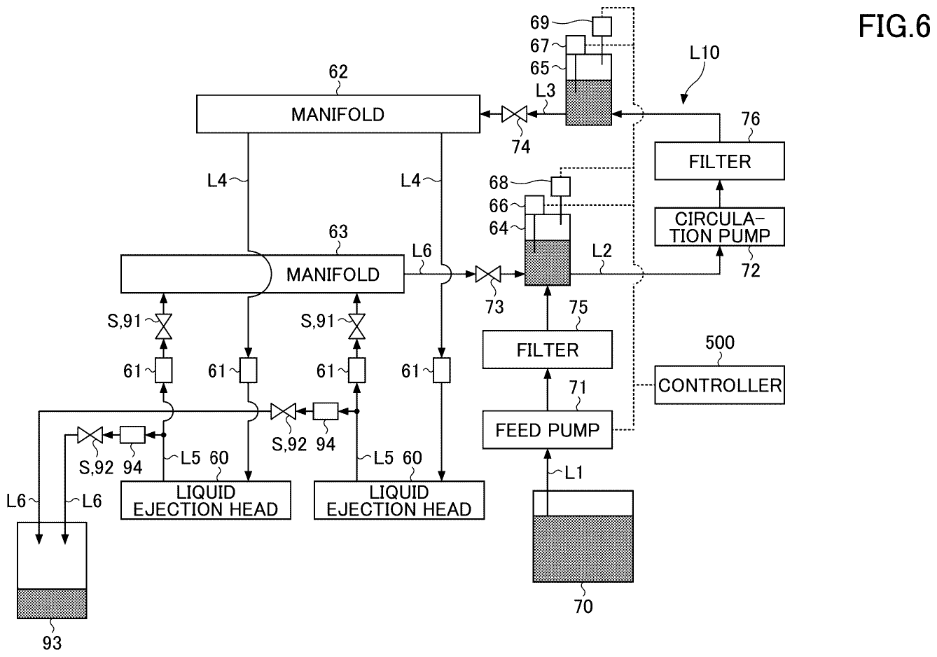

FIG. 6 is a diagram illustrating a configuration related to liquid circulation in the image forming apparatus 1 according to the present embodiment. As illustrated in FIG. 6, the image forming apparatus (liquid ejection apparatus) 1 includes the circulation channel L10 through which liquid circulates to be supplied to the liquid ejection head 60 and recovered from the liquid ejection head 60, and a controller 500. The circulation channel L10 is provided in each of the plurality of ink ejection units 2K, 2C, 2M, and 2Y and the pretreatment liquid ejection unit (pretreatment liquid applicator) 2A.

The image forming apparatus 1 further includes a main tank (cartridge) 70, which is a liquid storage that stores liquid such as ink and the pretreatment liquid ejected from the liquid ejection head 60, a first sub-tank 64, and a second sub-tank 65, a drainage tank 93, a feed pump 71, and a circulation pump 72. The feed pump 71 feeds (replenishes) liquid from the main tank 70 to the first sub-tank 64 via a liquid channel L1 including a filter 75. The first sub-tank 64 and the second sub-tank 65 are connected to each other via a liquid channel L2 and the feed pump 71 and a filter 76 are provided in the liquid channel L2.

Further, the image forming apparatus 1 includes a first manifold 62 communicating with the supply port 171 of the liquid ejection head 60, and a second manifold 63 communicating with the recovery port 181 of the liquid ejection head 60 via a recovery channel L5. The image forming apparatus 1 may include joints 61 for head replacement. The joints 61 are provided corresponding to each liquid ejection head 60.

The second sub-tank 65 is connected to the first manifold 62 via a liquid channel L3. The liquid channel L3 is provided with a solenoid valve 74 for opening and closing a flow channel.

The first sub-tank 64 is connected to the second manifold 63 via a drainage channel L6. The drainage channel L6 is provided with a solenoid valve 73 for opening and closing a flow channel.

The first manifold 62 communicates with the supply port 171 of the liquid ejection head 60 via a supply channel L4. The supply channel L4 is connected to the supply port 171 of the liquid ejection head 60 via a joint 61. A solenoid valve for opening and closing a flow channel may be provided in the supply channel L4 between the first manifold 62 and the joint 61.

The second manifold 63 communicates with the recovery port 181 of the liquid ejection head 60 via the recovery channel L5. The recovery channel L5 is connected to the recovery port 181 of the liquid ejection head 60 via a joint 61. A solenoid valve 91 for opening and closing a flow channel is provided in the recovery channel L5 between the second manifold 63 and the joint 61.

The drainage tank 93 communicates with a drainage channel L6 branching from the recovery channel L5 between the liquid ejection head 60 and the joint 61. The drainage channel L6 is provided with a joint 94 and a solenoid valve 92 for opening and closing a flow channel in this order from the upstream side. The drainage tank 93 stores different color ink or the pretreatment liquid that has entered from a nozzle of the liquid ejection head 60.

The drainage channel L6 may be directly connected to the drainage tank 93, or may be connected to another channel member that is directly connected to the drainage tank 93. In consideration of the possibility that the channel may be clogged by a component of the pretreatment liquid that has entered, the drainage channel L6 is preferably connected to the drainage tank 93 independently of other channel members.

The first sub-tank 64 and the second sub-tank 65 are respectively provided with liquid level detection sensors 66 and 67 serving as liquid level detection units, and air control units 68 and 69 configured to control the internal pressure. The liquid level refers to the vertical length from the bottom of each of the first sub-tank 64 and the second sub-tank 65 to a liquid surface. As each of the liquid level detection sensors 66 and 67, a float sensor, a method for using a plurality of electrode pins having different lengths to detect the presence or absence of ink based on the number of electrode pins that have detected ink, a liquid level detection method using a laser, or any other method may be used.

Each of the air control units 68 and 69 includes at least a pressure sensor for detecting the pressure in a corresponding sub-tank, and an air pump 77 for increasing or decreasing the pressure in the corresponding sub-tank, which will be described later. An air tank communicating with the corresponding sub-tank and having a larger capacity than the corresponding sub-tank may be disposed between each of the air control units 68 and 69 and the corresponding sub-tank to control the pressure in the air tank.

The circulation channel L10 is constituted by a channel started from the first sub-tank 64 and returning to the first sub-tank 64 via the liquid channel L2, the second sub-tank 65, the liquid channel L3, the first manifold 62, the supply channel L4, the liquid ejection head 60, the recovery channel L5, the second manifold 63, and the drainage channel L6.

Next, the supply, circulation and disposal of liquid will be described. When the liquid level detection sensor 67 detects a liquid shortage in the second sub-tank 65, liquid is supplied from the first sub-tank 64 to the second sub-tank 65 by using the circulation pump 72 in response to a signal from the controller 500. When the liquid level detection sensor 67 detects a full tank, the circulation pump 72 is stopped to stop the supply of the liquid from the first sub-tank 64 to the second sub-tank 65.

Similarly, when the liquid level detection sensor 66 detects a liquid shortage in the first sub-tank 64, liquid is supplied from the main tank 70 to the first sub-tank 64 by using the feed pump 71 in response to a signal from the controller 500. When the liquid level detection sensor 66 detects a full tank, the feed pump 71 is stopped to stop the supply of the liquid from the main tank 70 to the first sub-tank 64.

By forming a pressure difference between the first sub-tank 64 and the second sub-tank 65 by using the air control units 68 and 69, liquid can be circulated from the second sub-tank 65 to the first sub-tank 64 via the liquid channel L3, the first manifold 62, a plurality of supply channels L4, a plurality of liquid ejection heads 60, a plurality of recovery channels L5, the second manifold 63, and drainage channels L6. At this time, the solenoid valves 73 and 74 are open.

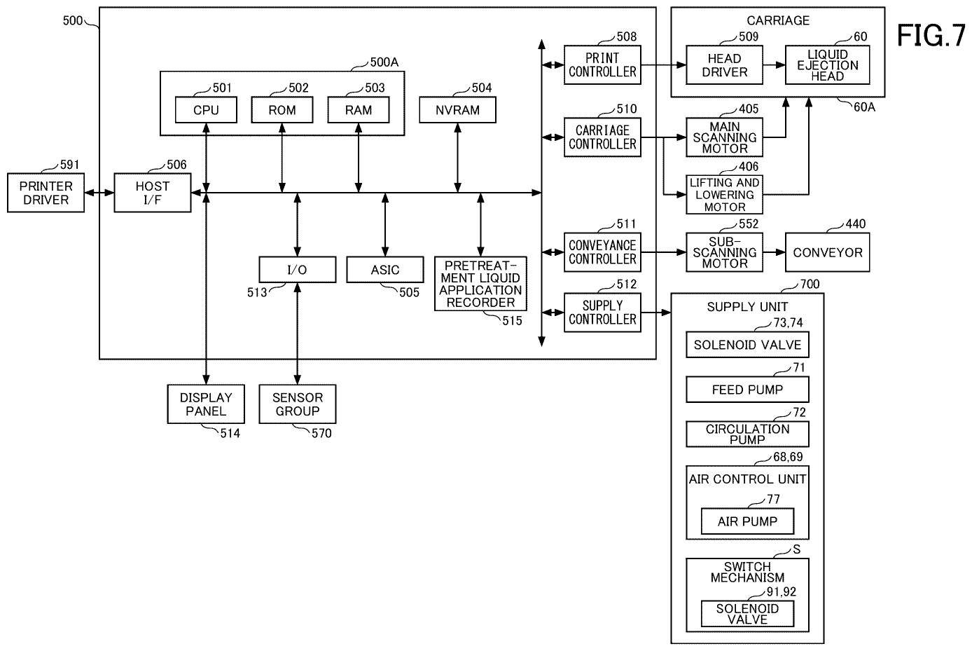

Next, an outline of the controller of the image forming apparatus will be described with reference to FIG. 7. FIG. 7 is a block diagram illustrating an example of a hardware configuration of the controller 500.

The controller 500 includes a main controller 500A. The main controller 500A includes a central processing unit (CPU) 501, a read-only memory (ROM) 502, and a random-access memory (RAM) 503. The CPU 501 controls the entire image forming apparatus, the ROM 502 stores fixed data such as various programs including a program executed by the CPU 501, and the RAM 503 temporarily stores image data and the like.

Further, the controller 500 includes a rewritable non-volatile memory (NVRAM) 504 and an ASIC 505. The NVRAM 504 retains data even when the power from a power supply of the apparatus is cut off, and the ASIC 505 processes various signals for image data and processes input/output signals for processing or rearranging images and for controlling the entire apparatus.

The controller 500 includes a print controller 508 including a data transfer unit and a drive signal generating unit for driving and controlling the liquid ejection head 60, and a head driver (driver IC) 509 for driving the liquid ejection head 60 provided on the carriage 60A side.

The controller 500 may include a pretreatment liquid application recorder 515 configured to record whether the pretreatment liquid is applied to a recording medium.

The controller 500 includes a carriage controller 510 configured to drive a main scanning motor 405 that moves (translates) the carriage 60A for scanning, and a lifting and lowering motor 406 that moves (lifts and lowers) the carriage 60A for scanning.

The controller 500 includes a conveyance controller 511 configured to drive a sub-scanning motor (paper conveyance motor) 552 that drives the conveyor 440.

The controller 500 includes a supply controller 512 configured to drive a supply unit 700. The supply unit 700 includes the solenoid valves 73 and 74 for closing off, opening, and switching the flow channel of liquid (such as ink, pretreatment fluid, or cleaning fluid), the pumps (the feed pump 71 and the circulation pump 72) that supplies the liquid, the air control units 68 and 69, and a switching mechanism S described later.

The controller 500 includes an input/output (I/O) unit 513. The I/O unit 513 acquires information from a jam sensor, a pressure sensor, the liquid level detection sensors 66 and 67, an encoder sensor, a temperature sensor, and a group of various other sensors 570 installed in the apparatus, extracts information necessary for controlling the apparatus, and uses the information for various controls.

A display panel 514 for inputting and displaying information necessary for the apparatus is connected to the controller 500.

The controller 500 includes an I/F 506 for transmitting and receiving data and signals to and from the host side. The controller 500 receives data and signals from a printer driver 591 of a host, such as an information processing apparatus such as a personal computer, an image reading apparatus, or an imaging apparatus, via a cable or a network through the I/F 506.

The CPU 501 of the controller 500 reads and analyzes print data in a reception buffer included in the I/F 506, performs necessary image processing and data rearrangement processing in the ASIC 505, and transfers the image data from the print controller 508 to the head driver 509. The print controller 508 transfers the above image data as serial data, and outputs a transfer clock, a latch signal, a control signal, and the like to the head driver 509, which are necessary for transferring the image data and determining the transfer.

The print controller 508 includes a drive signal generator including a digital/analog (D/A) converter configured to convert pattern data of drive pulses stored in the ROM 502 from digital to analog, a voltage amplifier, a current amplifier, and the like. The print controller 508 generates a drive waveform including one or more drive pulses and output the drive waveform to the head driver 509.

The head driver 509 selects drive pulses forming a drive waveform supplied from the print controller 508 based on image data corresponding to one line serially input into the liquid ejection head 60. The head driver 509 then applies the drive pulses to a pressure generating unit of the liquid ejection head 60, thereby driving the liquid ejection head 60. In this process, different sizes of dots (liquid droplets) such as large, medium, small sized droplets can be formed by selecting some or all of the drive pulses constituting the drive waveform or some or all of waveform components constituting the drive pluses.

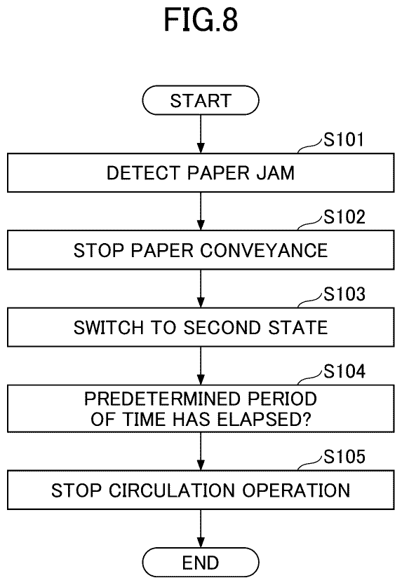

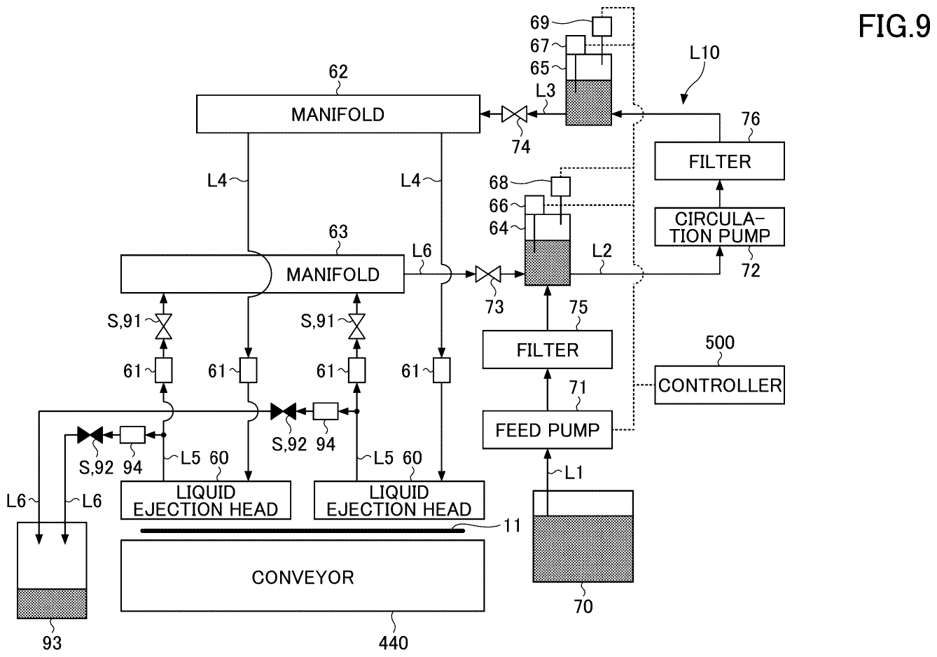

FIG. 8 is a flowchart illustrating an example of the operation of the image forming apparatus 1 when a paper jam occurs. FIG. 9 is a diagram illustrating the flow of liquid during normal printing in the image forming apparatus 1 according to the present embodiment. In FIG. 9, white solenoid valves are open, and black solenoid valves are closed.

FIG. 8 illustrates a flow controlled by the controller 500 when a paper jam occurs with normal printing as a trigger. In normal printing, as illustrated in FIG. 9, the solenoid valve 92 is closed, the solenoid valves 73, 74, and 91 are open, and the liquid is circulated in the circulation channel L10 in the image forming apparatus 1.

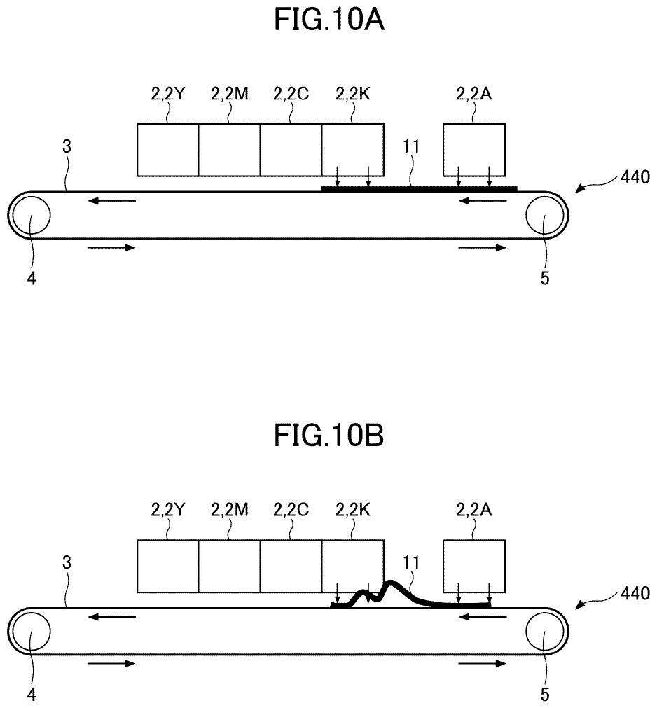

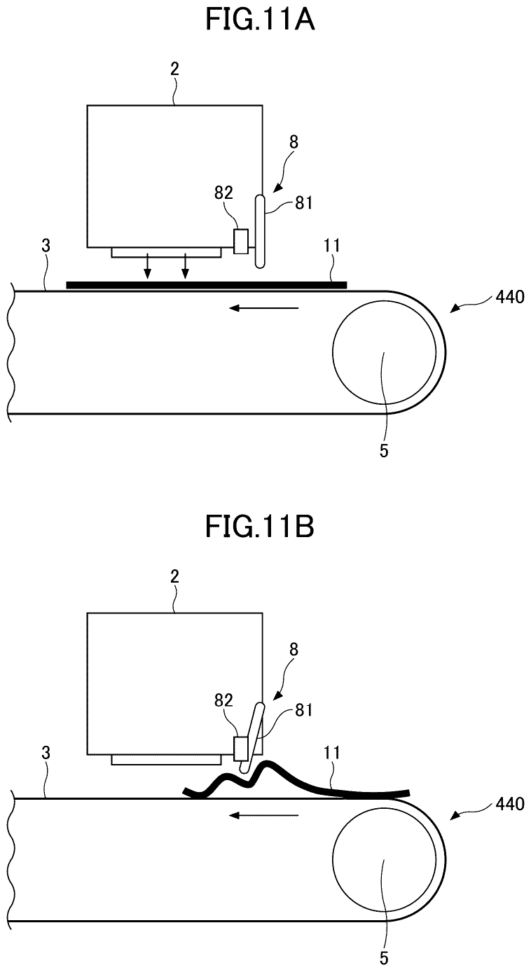

FIG. 10A is a diagram illustrating a state in normal printing. FIG. 10B is a diagram illustrating a state when a paper jam occurs. FIGS. 11A and 11B are diagrams illustrating the operation of a paper jam detector. In normal printing, as illustrated in FIG. 10A, the recording medium 11 is conveyed while facing liquid ejection heads 60. At a timing when the conveyed recording medium 11 reaches a predetermined position for image formation, the pretreatment liquid or ink is ejected from a liquid ejection head 60, thereby forming an image. At this time, for example, if the recording medium 11 is wrinkled, folded, or lifted, as illustrated in FIG. 10B, the liquid ejection head 60 would come into contact with the recording medium 11, thereby resulting in a paper jam.

When the recording medium 11 to which liquid (ink or the pretreatment liquid) is ejected comes into contact with the nozzle surface of the liquid ejection head 60, it is assumed that the ink ejected before the occurrence of the paper jam enters the inside of the nozzles. For example, if a paper jam of the recording medium 11 occurs when the recording medium 11 is printed with the cyan C ink after being printed with the black K ink, it is assumed that the black K ink on the recording medium 11 enters the inside of a liquid ejection head 60 of the liquid ejection unit 2C of the cyan C ink.

As illustrated in FIG. 11A, the image forming apparatus 1 includes a paper jam detector 8 configured to detect a paper jam of the recording medium 11. The paper jam detector 8 may include a paper jam detection plate 81 rotatably provided at an end portion of a liquid ejection unit 2 on the upstream side in the conveyance direction D1, and a paper jam detection sensor 82 (for example, a photo sensor) provided on the liquid ejection unit 2 and configured to detect the movement of the paper jam detection plate 81.

The tip on the recording medium 11 side of the paper jam detection plate 81 is located closer to the recording medium 11 than the nozzle surface of the liquid ejection head 60 is. Thus, as illustrated in FIG. 11B, when a paper jam occurs, the recording medium 11 contacts the paper jam detection plate 81 before the recording medium 11 contacts the nozzle surface of the liquid ejection head 60, and the paper jam detection sensor 82 detects the rotation of the paper jam detection plate 81, thereby detecting the paper jam.

The configuration of the paper jam detector 8 is not limited to that illustrated in FIG. 11 A and 11B, and the paper jam detector 8 may be, for example, a torque sensor configured to measure the torque of the paper conveyance motor 552, which is the drive source of the conveying belt 3. When a paper jam occurs, the load (torque) of the paper conveyance motor 552 increases. Thus, the paper jam can be detected by detecting the load of the paper conveyance motor 552 by the torque sensor. The torque sensor transmits a signal to the controller 500 when the load torque exceeds a predetermined value, for example

The paper jam detector 8 may be a physical sensor configured to detect contact of an object with each liquid ejection head 60 and the head array, an optical sensor configured to detect entry of an object into a nozzle surface region of each liquid ejection head 60, or a laser configured to detect lifting of the recording medium 11.

As illustrated in FIG. 8, the controller 500 detects a paper jam in step S101. When the paper jam detector 8 detects a paper jam, the paper jam detector 8 transmits a signal to the controller 500. Then, the controller 500 can detect the paper jam by receiving the signal.

Subsequently, in step S102, the controller 500 stops the conveyance of the recording medium 11. Specifically, the conveyance controller 511 stops the sub-scanning motor 552 for driving the conveyor 440 for conveying the recording medium 11.

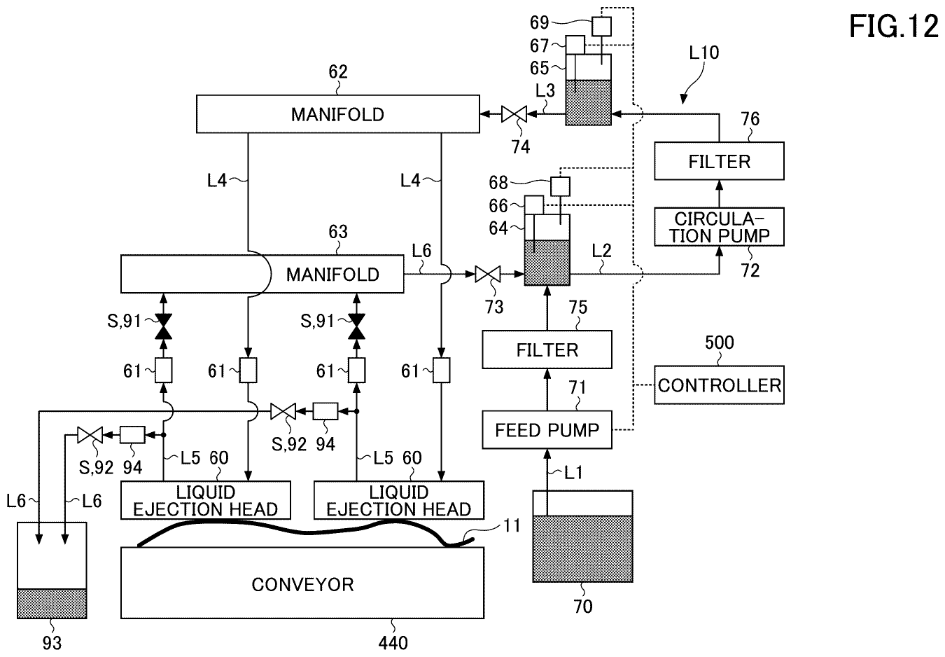

Subsequently, in step S103, the controller 500 performs control to switch to a second state. FIG. 12 is a diagram illustrating the flow of liquid when a paper jam occurs in the image forming apparatus 1 according to the present embodiment. In FIG. 12, white solenoid valves are open, and black solenoid valves are closed.

For example, the controller 500 (supply controller 512) performs control to close the solenoid valve 91 after opening the solenoid valve 92. As a result, as illustrated in FIG. 12, the channel (recovery channel L5) from the recovery port 181 of the liquid ejection head 60 to the second manifold 63 is switched to the channel (drainage channel L6) from the recovery port 181 of the liquid ejection head 60 to the discharge tank 93. That is, after the paper jam detector 8 detects the paper jam, the controller 500 performs control to switch from a first state (a state illustrated in FIG. 9) in which the recovery port 181 of the liquid ejection head 60 communicates with the second manifold 63 to the second state (the state illustrated in FIG. 12) in which the recovery port 181 of the liquid ejection head 60 communicates with the drainage channel L6.

The solenoid valve 91 and the solenoid valve 92 constitute the switching mechanism S that can switch between the first state and the second state. The switching mechanism S is included in the circulation channel L10. The switching mechanism S is not limited to the solenoid valve 91 and the solenoid valve 92, but may be, for example, a three-way solenoid valve provided at a branch point between the recovery channel L5 and the drainage channel L6.

Subsequently, in step S104, the controller 500 measures a predetermined period of time. Until the predetermined period of time elapses, a state in which the solenoid valve 92 is open and the solenoid valve 91 is closed (the channel illustrated in FIG. 12) is maintained. Instead of measuring the predetermined period of time, the controller 500 may detect the discharge amount of liquid into the drainage channel L6, and control the switching mechanism S such that the drainage channel L6 is closed off after the second state is maintained until the discharge amount reaches a predetermined value. Specifically, the controller 500 may perform control to detect the discharge amount of liquid into the drainage channel L6, maintain a state in which the solenoid valve 92 is open and the solenoid valve 91 is closed until the discharge amount reaches a predetermined value, and close the solenoid valve 92.

The discharge amount of liquid may be detected by a sensor provided in the drainage channel L6 or the drainage tank 93, for example. The controller 500 may proceed to step S105 without closing off the drainage channel L6 in step S104.

Subsequently, in step S105, the controller 500 stops a circulation operation. Specifically, the controller 500 (supply controller 512) performs control to close the solenoid valves 73 and 74. Instead of performing the control to close the solenoid valves 73 and 74, the controller 500 (supply controller 512) may stop the supply of the liquid by controlling the air control units 68 and 69.

After the above-described flow of the operation of the image forming apparatus 1 when a paper jam occurs is completed, for example, a user or the like performs maintenance such as nozzle check, suction, and pressurization. If it is confirmed that the liquid is properly discharged from the liquid ejection head 60, the controller 500 (supply controller 512) causes the circulation channel L10 of the image forming apparatus 1 to return to a state in which the solenoid valve 92 is closed, the solenoid valves 73, 74, and 91 are closed, and the liquid is circulating as illustrated in FIG. 9.

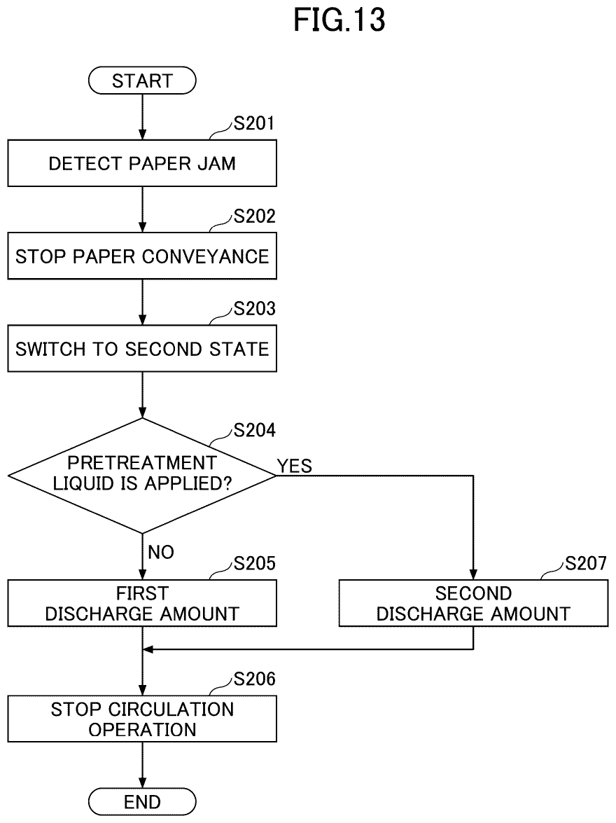

FIG. 13 is a flowchart illustrating an example of the operation of the image forming apparatus 1 when a paper jam occurs. Steps S201 to S203 are the same as steps S101 to S103 in FIG. 8, and thus the description thereof will be omitted.

After step S203, in step S204, the controller 500 determines whether the pretreatment liquid is applied to the recording medium 11, based on information recorded in the pretreatment liquid application recorder 515. If the controller 500 determines that the pretreatment liquid is not applied in step S204 (NO in step S204), in step S205, the controller 500 detects the discharge amount of liquid into the drainage channel L6, and controls the switching mechanism S such that the second state is maintained, specifically, the state in which the solenoid valve 92 is open and the solenoid valve 91 is closed is maintained, until the discharge amount reaches a predetermined value (hereinafter referred to as a “first discharge amount”).

Subsequently, in step S206, the controller 500 stops the circulation operation. Specifically, the controller 500 (supply controller 512) performs control to close the solenoid valves 73 and 74. Instead of performing the control to stop the solenoid valves 73 and 74, the controller 500 (supply controller 512) may stop the supply of the liquid by controlling the air control units 68 and 69.

If the controller 500 determines that the pretreatment liquid is applied in step S204 (YES in step S204), in step S207, the controller 500 detects the discharge amount of liquid into the drainage channel L6, and controls the switching mechanism S such that the second state is maintained, specifically, the state in which the solenoid valve 92 is open and the solenoid valve 91 is closed in maintained, until the discharge amount reaches a predetermined value (hereinafter referred to as a “second discharge amount”) that is greater than the first discharge amount. The first and second discharge amounts can be preset values.

Subsequently, in step S206, the controller 500 stops the circulation operation.

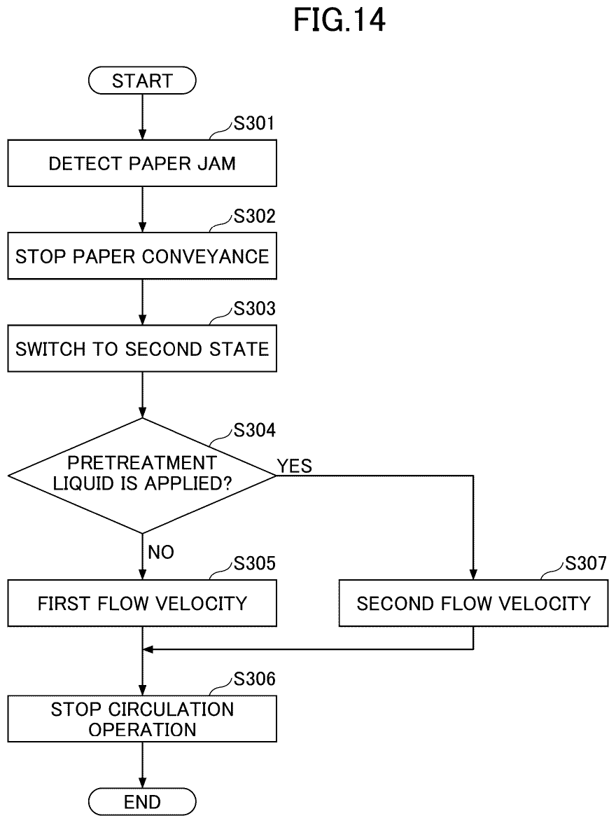

FIG. 14 is a flowchart illustrating an example of the operation of the image forming apparatus 1 when a paper jam occurs. Steps S301 to S304 are the same as steps S201 to S204 in FIG. 13, and the description thereof will be omitted.

If the controller 500 determines that the pretreatment liquid is not applied in step S304 (NO in step S304), in step S305, the controller 500 performs control such that the flow velocity of liquid flowing in the drainage channel L6 is a predetermined value (hereinafter referred to as a “first flow velocity”).

Subsequently, in step S306, the controller 500 stops the circulation operation. Specifically, the controller 500 (supply controller 512) performs control to close the solenoid valves 73 and 74. Instead of performing the control to close the solenoid valves 73 and 74, the controller 500 (supply controller 512) may stop the supply of the liquid by controlling the air control units 68 and 69.

If the controller 500 determines that the pretreatment liquid is applied in step S304 (YES in step S304), in step S307, the controller 500 performs control such that the flow velocity of liquid flowing in the drainage channel L6 is a predetermined value (hereinafter referred to as a “second flow velocity”) that is greater than the first flow velocity, that is, faster than the first flow velocity. Specifically, if the controller 500 determines that the pretreatment liquid is applied, the controller 500 performs control such that the pressure of the air control unit 69 is higher than the pressure of the air control unit 69 when the pretreatment liquid is determined not to be applied.

Subsequently, in step S306, the controller 500 stops the circulation operation.

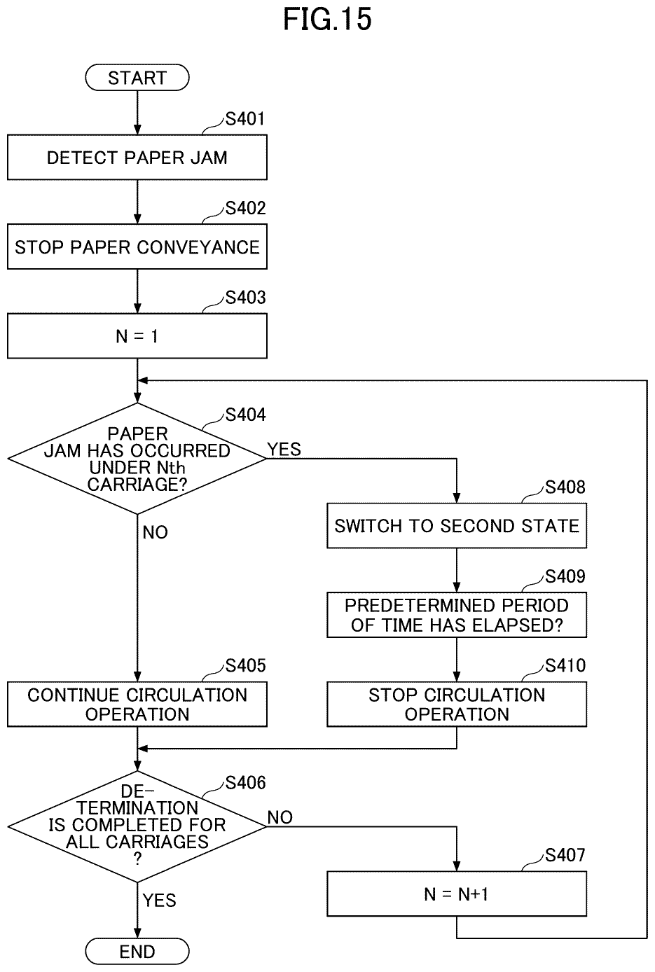

FIG. 15 is a flowchart illustrating an example of the operation of the image forming apparatus 1 when a paper jam occurs. Steps S401 and S402 are the same as steps S101 and S102 in FIG. 8, and thus the description thereof will be omitted.

As illustrated in FIG. 15, after step S402, the controller 500 sets a variable N to 1 in step S403.

Subsequently, in step S404, the controller 500 determines whether a paper jam has occurred directly under the Nth carriage 60A. Carriages are provided for the pretreatment liquid ejection unit 2A and the four color ink ejection units 2K, 2C, 2M, and 2Y, and the corresponding carriages are referred to as first to fifth carriages in this order.

For example, a torque sensor is provided for each of the carriages, the torque sensor detects an increase in the motor load of a conveying mechanism when a paper jam occurs, and the torque sensor transmits a signal to the controller 500 when the load torque exceeds a predetermined value. The controller 500 can detect the paper jam by receiving the signal.

The method of detecting a paper jam is not limited thereto, and may be a method of calculating the amount of conveyance from when a paper end is detected (printing is started) to when the load of a conveying motor is increased (a paper jam occurs). The method of detecting a paper jam may be a method in which a physical sensor that detects contact of an object with each liquid ejection head 60 and the head array, an optical sensor that detects entry of an object into a nozzle surface region of each liquid ejection head 60, or the like is provided for each carriage, and a paper jam is detected by the sensor.

If the controller 500 determines that a paper jam has not occurred directly under the Nth carriage 60A (N=1) in step S404 (NO in step S404), the controller 500 continues the circulation operation in step S405.

Subsequently, in step S406, the controller 500 determines whether a determination as to whether a paper jam has occurred directly under a carriage (step S404) is completed for all the carriages. If the controller 500 determines that the determination (step S404) is completed for all the carriages in step S406 (YES in step S406), the process ends.

If the controller 500 determines that the determination (step S404) is not completed for all the carriages in step S406 (NO in step S406), the variable N is set to N+1 in step S407. Then, the process returns to step S404, and the controller 500 repeats step S404 and the subsequent steps.

If the controller 500 determines that a paper jam has occurred directly under the Nth carriage 60A (N=1) in step S404 (YES in step S404), in step S408, the controller 500 controls a switching mechanism S of the Nth carriage 60 A (N=1) among the plurality of carriages 60A such that the first state is switched to the second state. For example, the controller 500 performs control to close a solenoid valve 91 after opening a solenoid valve 92. As a result, in the Nth carriage 60A (N=1), the channel (recovery channel L5) from the recovery port 181 of the liquid ejection head 60 to the second manifold 63 is switched to the channel (drainage channel L6) from the recovery port 181 of the liquid ejection head 60 to the drainage tank 93.

Subsequently, in step S409, the controller 500 measures a predetermined period of time. Until the predetermined period of time elapses, a state in which the solenoid valve 92 is open and the solenoid valve 91 is closed is maintained in the Nth carriage 60A (N=1). Instead of measuring the predetermined period of time, the controller 500 may detect the discharge amount of liquid into the drainage channel L6, and maintain a state in which the solenoid valve 92 is open and the solenoid valve 91 is closed until the discharge amount reaches a predetermined value. The discharge amount of liquid may be detected by a sensor provided in the drainage channel L6 or the drainage tank 93, for example.

Subsequently, in step S410, the controller 500 stops the circulation operation in the Nth carriage 60A (N=1). Specifically, the controller 500 performs control to close solenoid valves 73 and 74 in the Nth carriage 60A (N=1). Instead of performing the control to close the solenoid valves 73 and 74, the controller 500 may stop the supply of the liquid by controlling air control units 68 and 69.

Subsequently, the controller 500 causes the process to proceed to step S406. Step S406 and the subsequent steps are the same as those described above, and thus the description thereof will be omitted.

As described above, a liquid ejection apparatus 1 includes a conveyor 440, a paper jam detector 8, and a controller 500. A circulation channel L10 includes a first manifold 62, a second manifold 63, a drainage channel L6, a drainage tank 93, and a switching mechanism S. The controller 500 controls the switching mechanism S such that the first state is switched to the second state after a paper jam is detected by the paper jam detector 8.

With this configuration, different color ink or pretreatment liquid that has entered from a nozzle can be discharged into the drainage tank 93 via the drainage channel L6 by switching the flow channel when a paper jam of a recording medium 11 printed with the different color ink, a recording medium 11 to which the pretreatment liquid is applied, or a pre-treated recording medium 11 is detected. Accordingly, the liquid ejection apparatus 1 can discharge different color ink or pretreatment liquid that has entered a nozzle of an ink circulation head due to the occurrence of a paper jam, without contaminating the recording medium supporting member.

Further, in the liquid ejection apparatus 1, different color ink or pretreatment liquid that has entered from a nozzle can be prevented from entering the second manifold 63 located downstream of a liquid ejection head 60 and from entering the entire circulation channel L10.

In the case of a normal liquid ejection head, restoration can be performed only by maintenance for discharging mixed color ink from the inside of the liquid ejection head (for example, by suction maintenance for sucking and discharging the ink from the head nozzle surface using a cap or the like, pressurization maintenance for pressurizing the liquid ejection head and discharging the mixed color ink from a nozzle, or the like).

In the case of an ink circulation head, there is a possibility that different color ink or pretreatment liquid that has entered a nozzle of the ink circulation head enters not only the head but also the entire channel by the circulation operation of the ink circulation head. In order to eliminate color mixing, it is necessary to discharge the entire liquid in the channel through which the liquid circulates and to fill the channel with new ink or new pretreatment liquid again. In addition, if aggregates are clogged in the channel, the ink circulation head needs to be replaced, and restoration would become more difficult.

Conversely, in the liquid ejection apparatus 1 according to the present embodiment, different color ink or pretreatment liquid that has entered from a nozzle can be prevented from entering the second manifold 63 located downstream of the liquid ejection head 60 and from entering the entire circulation channel L10. Thus, restoration can be easily performed.

The liquid ejection apparatus includes a plurality of ink ejection units 2K, 2C, 2M, and 2Y and a pretreatment liquid applicator 2A. The plurality of ink ejection units 2K, 2C, 2M, and 2Y are arranged downstream of the pretreatment liquid applicator 2A in a conveyance direction D1.

With this configuration, in a case where pretreatment liquid is applied to the recording medium 11, the pretreatment liquid can be discharged even when a paper jam of the recording medium 11 occurs and the pretreatment liquid on the recording medium 11 adheres to a nozzle of the liquid ejection head 60 and enters the inside of the nozzle. Thus, the pretreatment liquid can be prevented from contacting ink inside the nozzle or the supply channel, thereby avoiding formation of aggregates and clogging of the nozzle and the circulation channel L10.

The pretreatment liquid applicator 2A is a pretreatment liquid ejection unit having a corresponding circulation channel L10 and configured to eject the pretreatment liquid from a corresponding liquid ejection head 60.

With this configuration, in a case where the pretreatment liquid applicator 2A is a pretreatment liquid ejection unit, the pretreatment liquid can be discharged even when the pretreatment liquid on the recording medium adheres to a nozzle of a liquid ejection head 60 and enters the inside of the nozzle. Thus, the pretreatment liquid can be prevented from contacting ink inside the nozzle or the supply channel, thereby avoiding formation of aggregates and clogging of the nozzle and the circulation channel L10.

After the controller 500 controls the switching mechanism S such that the first state is switched to the second state, the controller 500 detects the discharge amount of liquid into the drainage channel L6, and controls the switching mechanism S such that the drainage channel L6 is closed off after the second state is maintained until the discharge amount reaches a predetermined value.

With this configuration, the liquid ejection apparatus 1 can sufficiently discharge different color ink or the pretreatment liquid, which has entered from a nozzle, into the drainage channel L6.

The liquid ejection apparatus 1 includes a pretreatment liquid application recorder 515. In response to the paper jam being detected, the controller 500 determines whether the pretreatment liquid is applied to the recording medium, based on information recorded in the pretreatment liquid application recorder 515, and in a case where the controller 500 determines that the pretreatment liquid is applied to the recording medium, the controller 500 controls the switching mechanism S such that the second state is maintained until the discharge amount reaches a first predetermined value that is greater than a second predetermined value, the second predetermined value corresponding to a case where the pretreatment liquid is determined not to be applied.

In a case where the pretreatment liquid is not applied, the trouble is ink color mixing, and no coagulating components are present. Thus, ink does not adhere in a head. However, in a case where the pretreatment liquid is applied, there is a possibility that the ink adheres in the head due to coagulation of the pretreatment liquid and the ink. Therefore, it is necessary to more strongly discharge the pretreatment liquid that has entered from a nozzle. Accordingly, with the above-described configuration, the liquid ejection apparatus 1 can be easily restored by increasing the discharge amount.

The liquid ejection apparatus 1 includes a pretreatment liquid application recorder 515. In response to the paper jam being detected, the controller 500 determines whether the pretreatment liquid is applied to the recording medium, based on information recorded in the pretreatment liquid application recorder 515, and in a case where the controller 500 determines that the pretreatment liquid is applied to the recording medium, the controller 500 performs control such that a first flow velocity of the liquid flowing in the drainage channel L6 is greater than a second flow velocity, the second flow velocity corresponding to a case where the pretreatment liquid is determined not to be applied.

With this configuration, in a case where the pretreatment liquid is applied, the liquid ejection apparatus 1 can be easily restored by increasing the flow velocity.

The liquid ejection apparatus includes a plurality of carriages 60A corresponding to the plurality of ink ejection units 2K, 2C, 2M, and 2Y and to the pretreatment liquid ejection unit 2A. The controller 500 determines whether the paper jam has occurred directly under each of the plurality of carriages 60A, and in a case where the controller 500 determines that the paper jam has occurred directly under a carriage 60A among the plurality of carriages 60A, the controller 500 controls a switching mechanism S of the carriage 60A such that the first state is switched to the second state.

In a case where it takes a long time to discharge different color ink or the pretreatment liquid that has entered from a nozzle or to perform maintenance, if the circulation operation is stopped in the ink ejection units 2K, 2C, 2M, or 2Y in which different color ink or the pretreatment liquid has not entered, or in the pretreatment liquid ejection unit 2A, nozzles may dry out and become clogged due to drying in a decapped state. Thus, there is a possibility that an ejection failure occurs even in a head having no nozzle clogging problem. Conversely, according to the present embodiment, the liquid ejection apparatus 1 with the above-described configuration can prevent a liquid ejection head 60 having no clogging problem from experiencing an ejection failure.

An image forming apparatus includes the liquid ejection apparatus according to the present embodiment, wherein an image is formed on the recording medium.

With this configuration, because the image forming apparatus 1 includes the liquid ejection apparatus according to the present embodiment, different color ink or the pretreatment liquid that has entered a nozzle of an ink circulation head due to the occurrence of a paper jam can be discharged, without contaminating the recording medium supporting member.

An image forming system 100 includes the image forming apparatus 1 according to the present embodiment; a paper feeder 10 configured to feed the recording medium; a dryer 30 configured to dry the recording medium on which the image is formed; and a paper ejector 40 configured to eject the dried recording medium.

With this configuration, because the image forming system 100 includes the image forming apparatus 1 according to the present embodiment, different color ink or pretreatment liquid that has entered a nozzle of an ink circulation head due to the occurrence of a paper jam can be discharged without contaminating the recording medium supporting member.

Aspects of the present disclosure are as follows, for example.

<Clause 1> A liquid ejection apparatus having a circulation channel through which liquid is supplied to a liquid ejection head and recovered from the liquid ejection head, the liquid ejection apparatus including:
a conveyor configured to convey a recording medium;
a paper jam detector configured to detect a paper jam of the recording medium; and
a controller,
wherein the circulation channel includes
   a first manifold leading to a supply port of the liquid ejection head,
   a second manifold leading to a recovery port of the liquid ejection head via a recovery channel,
   a drainage channel branching from the recovery channel,
   a drainage tank leading to the drainage channel, and
   a switching mechanism configured to switch between a first state in which the recovery port of the liquid ejection head communicates with the second manifold and a second state in which the recovery port of the liquid ejection head communicates with the drainage channel, and
wherein the controller controls the switching mechanism such that the first state is switched to the second state after the paper jam is detected by the paper jam detector.

<Clause 2> The liquid ejection apparatus according to clause 1, further including:
a plurality of ink ejection units; and
a pretreatment liquid applicator configured to apply pretreatment liquid to the recording medium, wherein
the circulation channel includes a plurality of circulation channels and the liquid ejection head includes a plurality of liquid ejection heads,
the plurality of ink ejection units have corresponding ones of the plurality of circulation channels and configured to eject inks of mutually different colors from corresponding ones of the plurality of liquid ejection heads, and
the plurality of ink ejection units are arranged downstream of the pretreatment liquid applicator in a conveyance direction of the recording medium. <Clause 3> The liquid ejection apparatus according to clause 2, wherein the pretreatment liquid applicator is a pretreatment liquid ejection unit having a corresponding one of the plurality of circulation channels and configured to eject the pretreatment liquid from a corresponding one of the plurality of liquid ejection heads.

<Clause 4> The liquid ejection apparatus according to any one of clauses 1 to 3, wherein, after the controller controls the switching mechanism such that the first state is switched to the second state, the controller detects a discharge amount of the liquid into the drainage channel, and controls the switching mechanism such that the drainage channel is closed off after the second state is maintained until the discharge amount reaches a predetermined value.

<Clause 5> The liquid ejection apparatus according to any one of clauses 1 to 4, further including:
a pretreatment liquid application recorder configured to record whether the pretreatment liquid is applied to the recording medium, wherein
in response to the paper jam being detected, the controller determines whether the pretreatment liquid is applied to the recording medium, based on information recorded in the pretreatment liquid application recorder, and in a case where the controller determines that the pretreatment liquid is applied to the recording medium, the controller controls the switching mechanism such that the second state is maintained until the discharge amount reaches a first predetermined value that is greater than a second predetermined value, the second predetermined value corresponding to a case where the pretreatment liquid is determined not to be applied.

<Clause 6> The liquid ejection apparatus according to any one of clauses 1 to 4, further including:
a pretreatment liquid application recorder configured to record whether the pretreatment liquid is applied to the recording medium, wherein
in response to the paper jam being detected, the controller determines whether the pretreatment liquid is applied to the recording medium, based on information recorded in the pretreatment liquid application recorder, and in a case where the controller determines that the pretreatment liquid is applied to the recording medium, the controller performs control such that a first flow velocity of the liquid flowing in the drainage channel is greater than a second flow velocity, the second flow velocity corresponding to a case where the pretreatment liquid is determined not to be applied.

<Clause 7> The liquid ejection apparatus according to any one of clauses 1 to 6, further including:
a plurality of carriages corresponding to the plurality of ink ejection units and to the pretreatment liquid ejection unit, wherein
the controller determines whether the paper jam has occurred directly under each of the plurality of carriages, and in a case where the controller determines that the paper jam has occurred directly under a carriage among the plurality of carriages, the controller controls a switching mechanism of the carriage such that the first state is switched to the second state.

<Clause 8> An image forming apparatus including:
the liquid ejection apparatus of any one of clause 1 to 7, wherein
an image is formed on the recording medium.

<Clause 9> An image forming system including:
the image forming apparatus of clause 8;
a paper feeder configured to feed the recording medium;
a dryer configured to dry the recording medium on which the image is formed; and
a paper ejector configured to eject the dried recording medium.

A liquid ejection apparatus according to an embodiment of the present disclosure can discharge different color ink or pretreatment liquid that has entered a nozzle of an ink circulation head due to the occurrence of a paper jam, without contaminating a recording medium supporting member.

What is claimed is:

1. A liquid ejection apparatus having a circulation channel through which liquid is supplied to a liquid ejection head and recovered from the liquid ejection head, the liquid ejection apparatus comprising:
a conveyor configured to convey a recording medium;
a paper jam detector configured to detect a paper jam of the recording medium; and
a controller,
wherein the circulation channel includes
a first manifold leading to a supply port of the liquid ejection head,
a second manifold leading to a recovery port of the liquid ejection head via a recovery channel,
a drainage channel branching from the recovery channel,
a drainage tank leading to the drainage channel, and
a switching mechanism configured to switch between a first state in which the recovery port of the liquid ejection head communicates with the second manifold and a second state in which the recovery port of the liquid ejection head communicates with the drainage channel, and
wherein the controller controls the switching mechanism such that the first state is switched to the second state after the paper jam is detected by the paper jam detector.

2. The liquid ejection apparatus according to claim 1, further comprising:
a plurality of ink ejection units; and
a pretreatment liquid applicator configured to apply pretreatment liquid to the recording medium, wherein
the circulation channel includes a plurality of circulation channels and the liquid ejection head includes a plurality of liquid ejection heads,
the plurality of ink ejection units have corresponding ones of the plurality of circulation channels and configured to eject inks of mutually different colors from corresponding ones of the plurality of liquid ejection heads, and
the plurality of ink ejection units are arranged downstream of the pretreatment liquid applicator in a conveyance direction of the recording medium.

3. The liquid ejection apparatus according to claim 2, wherein the pretreatment liquid applicator is a pretreatment liquid ejection unit having a corresponding one of the plurality of circulation channels and configured to eject the pretreatment liquid from a corresponding one of the plurality of liquid ejection heads.

4. The liquid ejection apparatus according to claim 3, wherein, after the controller controls the switching mechanism such that the first state is switched to the second state, the controller detects a discharge amount of the liquid into the drainage channel, and controls the switching mechanism such that the drainage channel is closed off after the second state is maintained until the discharge amount reaches a predetermined value.

5. The liquid ejection apparatus according to claim 4, further comprising:
a pretreatment liquid application recorder configured to record whether the pretreatment liquid is applied to the recording medium, wherein
in response to the paper jam being detected, the controller determines whether the pretreatment liquid is applied to the recording medium, based on information recorded in the pretreatment liquid application recorder, and in a case where the controller determines that the pretreatment liquid is applied to the recording medium, the controller controls the switching mechanism such that the second state is maintained until the discharge amount reaches a first predetermined value that is greater than a second predetermined value, the second predetermined value corresponding to a case where the pretreatment liquid is determined not to be applied.

6. The liquid ejection apparatus according to claim 4, further comprising:
a pretreatment liquid application recorder configured to record whether the pretreatment liquid is applied to the recording medium, wherein
in response to the paper jam being detected, the controller determines whether the pretreatment liquid is applied to the recording medium, based on information recorded in the pretreatment liquid application recorder, and in a case where the controller determines that the pretreatment liquid is applied to the recording medium, the controller performs control such that a first flow velocity of the liquid flowing in the drainage channel is greater than a second flow velocity, the second flow velocity corresponding to a case where the pretreatment liquid is determined not to be applied.

7. The liquid ejection apparatus according to claim 4, further comprising:
a plurality of carriages corresponding to the plurality of ink ejection units and to the pretreatment liquid ejection unit, wherein
the controller determines whether the paper jam has occurred directly under each of the plurality of carriages, and in a case where the controller determines that the paper jam has occurred directly under a carriage among the plurality of carriages, the controller controls a switching mechanism of the carriage such that the first state is switched to the second state.

8. An image forming apparatus comprising:
the liquid ejection apparatus of claim 1, wherein
an image is formed on the recording medium.

9. An image forming system comprising:
the image forming apparatus of claim 8;
a paper feeder configured to feed the recording medium;
a dryer configured to dry the recording medium on which the image is formed; and
a paper ejector configured to eject the dried recording medium.
